(19) United States
(12) Patent Application Publication
(10) Pub. No.: US 2019/0161576 A1
(43) Pub. Date: May 30, 2019

(54) POLYCARBONATE COMPOSITIONS CONTAINING A CARBOXYLIC ACID AND THEIR GLYCEROL OR DIGLYCEROL ESTERS

(71) Applicant: Covestro Deutschland AG, Leverkusen (DE)

(72) Inventors: Rolf WEHRMANN, Krefeld (DE); Helmut Werner HEUER, Leverkusen (DE); Anke BOUMANS, Goch (DE)

(21) Appl. No.: 16/301,840

(22) PCT Filed: May 19, 2017
(86) PCT No.: PCT/EP2017/062079

§ 371 Date: Nov. 15, 2018

(30) Foreign Application Priority Data
May 19, 2016 (EP) 16170251.9

(51) Int. Cl. C08G 64/18; C08G 64/30; C08G 64/08; C08K 5/103; C08L 69/00; C08K 5/09

(52) U.S. Cl. CPC C08G 64/18; C08G 64/307; C08G 64/081; C08K 5/005; C08L 69/00; C08K 5/09; C08K 5/103

(57) ABSTRACT

The invention relates to compositions comprising polycarbonate and to a mixture comprising a carboxylic acid and the glycerol and/or diglycerol esters thereof, to the use of the compositions for production of blends or mouldings and to mouldings obtainable therefrom. The compositions have improved rheological and optical properties.

The invention relates to compositions comprising polycarbonate and flowability improvers and to mouldings obtainable from the compositions. The compositions have improved rheological and optical properties.

Particularly in the case of thin-wall (housing) parts, for example for ultrabooks, smartphones or smartbooks, a low melt viscosity is required in order that components having a uniform wall thickness can be achieved. Further fields of application in which good flowabilities are required are in the automotive sector (for example headlamp covers, visors, optical fibre systems) and in the electrics and electronics sector (lighting components, housing parts, covers, smart meter applications).

Bisphenol A diphosphate (BDP) is conventionally used for flow improvement, in amounts of up to more than 10 wt % in order to achieve the desired effect. However, this markedly reduces heat resistance.

The prior art does not give the person skilled in the art any pointer as to how flowability and simultaneously the optical properties of polycarbonate compositions can be improved with virtually the same heat resistance.

The prior art discloses compositions which have high transparency and good heat resistance, but are in need of further improvement in terms of flowability, for instance in DE 10 2009 007762 A1, WO 2010/072344 A1 and US 2005/215750 A1.

The problem addressed was therefore that of finding compositions comprising aromatic polycarbonate which have improved optical properties and simultaneously improved flowability combined with virtually the same heat resistance.

It has been found that, surprisingly, polycarbonate compositions have improved flowability and better optical properties whenever particular amounts of carboxylic acids and the glycerol and/or diglycerol esters thereof are present. The heat resistance (Vicat temperature) remains virtually unchanged.

The polycarbonate compositions comprising the carboxylic acids and the glycerol and/or diglycerol esters thereof preferably exhibit good melt stabilities with improved rheological properties, namely a higher melt volume flow rate (MVR) determined to DIN EN ISO 1133:2012-03 (at a test temperature of 300° C., mass 1.2 kg), an improved melt viscosity determined to ISO 11443:2005, and improved optical properties measurable by a lower yellowness index (YI) and/or by a higher optical transmission, determined to ASTM E 313-10, compared to equivalent compositions otherwise comprising the same components save for the carboxylic acids and the glycerol or diglycerol esters thereof. The compositions still feature good mechanical properties, measurable for example via notched impact strength determined to ISO 7391-2:2006 or via impact strength determined to ISO 7391-2:2006.

The present invention therefore provides compositions comprising A) 20.0 wt % to 99.95 wt % of aromatic polycarbonate and B) 0.05 wt % to 10.0 wt % of a mixture comprising at least one saturated or unsaturated monocarboxylic acid having a chain length of 6 to 30 carbon atoms and at least one ester of this monocarboxylic acid based on glycerol and/or diglycerol.

The compositions preferably comprise
A) 20.0 wt % to 99.95 wt %, further preferably 83.0 to 99.80 wt %, of aromatic polycarbonate,
B) 0.05 wt % to 10.0 wt %, more preferably 0.1 to 8.0 wt %, even more preferably 0.2 to 6.0 wt %, of the mixture comprising at least one saturated or unsaturated monocarboxylic acid having a chain length of 6 to 30 carbon atoms and at least one ester of the monocarboxylic acid based on glycerol and/or diglycerol,
C) 0.0 wt % to 1.0 wt % of thermal stabilizer and
D) 0.0 wt % to 8.0 wt % of further additives.

Further preferably, compositions of this kind consist of
A) 87.0 wt % to 99.95 wt % of aromatic polycarbonate,
B) 0.05 wt % to 6.0 wt/o of the mixture comprising at least one saturated or unsaturated monocarboxylic acid having a chain length of 6 to 30 carbon atoms and at least one ester of the monocarboxylic acid based on glycerol and/or diglycerol,
C) 0.0 wt % to 1.0 wt % of thermal stabilizer and
D) 0.0 wt % to 6.0 wt % of one or more further additives from the group of the antioxidants, demoulding agents, flame retardants, UV absorbers, IR absorbers, antistats, optical brighteners, colourants from the group of the organic or inorganic pigments, additives for laser marking and/or impact modifiers,
   the composition most preferably being transparent and the additive(s) being selected from the group of the antioxidants, demoulding agents, flame retardants, UV absorbers, IR absorbers, antistats, optical brighteners, colourants from the group of the organic pigments, and/or additives for laser marking.

The compositions according to the invention are preferably transparent.

“Transparent” in the context of the invention means that the compositions have a visual transmission Ty (D65 observed at 10°) of at least 84%, determined to ISO 13468-2:2006 at a thickness of 4 mm, and a haze of <5%, determined to ASTM D1003:2013 at a layer thickness of 4 mm.

Through the use of the mixture comprising the monocarboxylic acid and the glycerol or diglycerol esters thereof in transparent polycarbonate compositions, it is possible with preference also to improve the optical properties. Addition of the mixture increases transmission, determined to ISO 13468-2:2006 at thickness 4 mm.

In the description of the invention which follows, C₁- to C₄-alkyl in the context of the invention is, for example, methyl, ethyl, n-propyl, isopropyl, n-butyl, sec-butyl, tert-butyl, and C₁- to C₆-alkyl is additionally for example n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,3-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl. C₁- to C₁₀-alkyl is additionally for example n-heptyl and n-octyl, pinacyl, adamantyl, the isomeric menthyls, n-nonyl, n-decyl. C₁- to C₃₄-alkyl is additionally for example n-dodecyl, n-tridecyl, n-tetradecyl, n-hexadecyl or n-octadecyl. The same applies for the corresponding alkyl radical for example in aralkyl/alkylaryl, alkylphenyl or alkylcarbonyl radicals. Alkylene radicals in the corresponding hydroxyalkyl or aralkyl/alkylaryl radicals represent for example the alkylene radicals corresponding to the preceding alkyl radicals.

Aryl is a carbocyclic aromatic radical having 6 to 34 skeletal carbon atoms. The same applies for the aromatic part of an arylalkyl radical, also known as an aralkyl radical, and for aryl constituents of more complex groups, for example arylcarbonyl radicals.

Examples of C₆- to C₃₄-aryl are phenyl, o-, p-, m-tolyl, naphthyl, phenanthrenyl, anthracenyl or fluorenyl.

Arylalkyl and aralkyl each independently represent a straight-chain, cyclic, branched or unbranched alkyl radical as defined above which may be mono-, poly- or persubstituted by aryl radicals as defined above.

In the context of the present invention—unless explicitly stated otherwise—the stated wt % values for the components A, B, C and D are each based on the total weight of the composition. The composition may contain further components in addition to components A, B, C and D. In a preferred embodiment the composition comprises no further components and components A) to D) add up to 100 wt/%, i.e. the composition consists of components A, B, C and D.

The compositions according to the invention are preferably used for producing mouldings. The compositions preferably have a melt volume flow rate (MVR) of 2 to 120 cm³/(10 min), more preferably of 3 to 90 cm³/(10 min) determined to ISO 1133:2012-3 (test temperature 300° C., mass 1.2 kg).

The individual constituents of the compositions according to the invention are more particularly elucidated hereinbelow:

Component A

In the context of the invention, the term “polycarbonate” is understood to mean both homopolycarbonates and copolycarbonates. These polycarbonates may be linear or branched in the familiar manner. Mixtures of polycarbonates may also be used according to the invention.

The composition according to the invention comprises, as component A, 20.0 wt % to 99.95 wt % of aromatic polycarbonate. The amount of the aromatic polycarbonate in the composition is preferably at least 50 wt %, further preferably at least 60 wt % and even further preferably at least 75 wt %, more preferably at least 82 wt %, most preferably at least 87 wt %, where a single polycarbonate or a mixture of a plurality of polycarbonates may be present.

The polycarbonates present in the compositions are produced in a known manner from diphenols, carbonic acid derivatives, optionally chain terminators and branching agents.

Particulars pertaining to the production of polycarbonates are disclosed in many patent documents spanning about the last 40 years. Reference is made here, for example, to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetate, Polyester, Celluloseester, Carl Hanser Verlag Munich, Vienna 1992, pages 117 to 299.

Aromatic polycarbonates are produced for example by reaction of diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Another possibility is production by way of a melt polymerization process via reaction of diphenols with, for example, diphenyl carbonate.

Diphenols suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl)sulphides, bis(hydroxyphenyl)ethers, bis(hydroxyphenyl)ketones, bis(hydroxyphenyl)sulphones, bis(hydroxyphenyl)sulphoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred diphenols are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

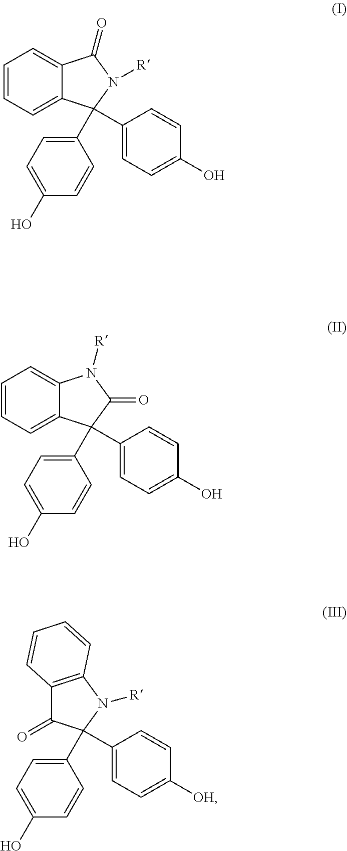

in which R′ in each case is C₁- to C₄-alkyl, aralkyl or aryl, preferably methyl or phenyl, most preferably methyl.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A and also the diphenols of formulae (I), (II) and (III).

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates only one diphenol is employed and in the case of copolycarbonates two or more diphenols are employed.

Examples of suitable carbonic acid derivatives include phosgene or diphenyl carbonate.

Suitable chain terminators that may be employed in the production of polycarbonates are monophenols. Suitable monophenols are for example phenol itself, alkylphenols such as cresols, p-tert-butylphenol, cumylphenol and mixtures thereof.

Preferred chain terminators are the phenols mono- or polysubstituted by linear or branched C₁- to C₃₀-alkyl radicals, preferably unsubstituted or substituted by tert-butyl. Particularly preferred chain terminators are phenol, cumylphenol and/or p-tert-butylphenol.

The amount of chain terminator to be employed is preferably 0.1 to 5 mol % based on the moles of diphenols employed in each case. The chain terminators can be added before, during or after the reaction with a carbonic acid derivative.

Suitable branching agents are the trifunctional or more than trifunctional compounds familiar in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional employment is preferably from 0.05 mol % to 2.00 mol % based on moles of diphenols used in each case.

The branching agents can either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-33,5-trimethylcyclohexane and also homo- or copolycarbonates derived from the diphenols of formulae (I), (II) and (III)

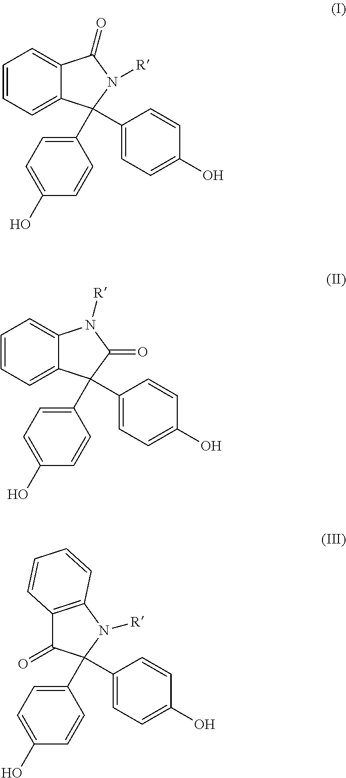

in which R′ in each case is C₁- to C₄-alkyl, aralkyl or aryl, preferably methyl or phenyl, most preferably methyl.

To achieve incorporation of additives, component A is preferably employed in the form of powders, pellets or mixtures of powders and pellets.

The polycarbonate employed may also be a mixture of different polycarbonates, for example of polycarbonates A1 and A2:

The amount of the aromatic polycarbonate A1 based on the total amount of polycarbonate is from 25.0 to 85.0 wt %, preferably from 28.0 to 84.0 wt %, more preferably from 30.0 to 83.0 wt %, this aromatic polycarbonate being based on bisphenol A with a preferred melt volume flow rate MVR of 7 to 15 cm³/(10 min), more preferably with a melt volume flow rate MVR of 8 to 12 cm³/(10 min) and yet more preferably with a melt volume flow rate MVR of 8 to 11 cm³/(10 min), determined according to ISO 1133 (test temperature 300° C., mass 1.2 kg).

The amount of pulverulent aromatic polycarbonate A2 relative to the overall amount of polycarbonate is from 3.0 to 12.0 wt %, preferably from 4.0 to 11.0 wt % and more preferably from 4.0 to 10.0 wt %, and this aromatic polycarbonate is preferably based on bisphenol A with a preferred melt volume flow rate MVR of 3 to 8 cm³/(10 min); more preferably with a melt volume flow rate MVR of 4 to 7 cm³/(10 min) and yet more preferably with a melt volume flow rate MVR of 6 cm³/(10 min), determined according to ISO 1133 (test temperature 300° C., mass 1.2 kg).

In a preferred embodiment the composition comprises as component A a copolycarbonate comprising one or more monomer units of formula (1)

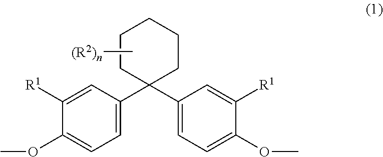

where
R¹ is hydrogen or C₁- to C₄-alkyl radicals, preferably hydrogen,
R² is C₁- to C₄-alkyl radicals, preferably a methyl radical,
n is 0, 1, 2 or 3, preferably 3,
   optionally in combination with a further aromatic homo- or copolycarbonate comprising one or more monomer units of general formula (2)

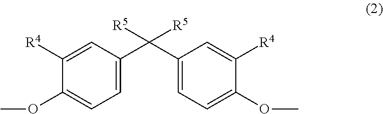

where
R⁴ is H, linear or branched C₁- to C₁₀-alkyl radicals, preferably linear or branched C₁- to C₆-alkyl radicals, more preferably linear or branched C₁- to C₄-alkyl radicals, most preferably H or a C₁-alkyl radical (methyl radical), and
R⁵ is linear or branched C₁- to C₁₀-alkyl radicals, preferably linear or branched C₁- to C₆-alkyl radicals, more preferably linear or branched C₁- to C₄-alkyl radicals, most preferably a C₁-alkyl radical (methyl radical);
   and where the further homo- or copolycarbonate which is optionally additionally present contains no monomer units of formula (1).

The monomer unit(s) of general formula (1) is/are introduced via one or more corresponding diphenols of general formula (1′):

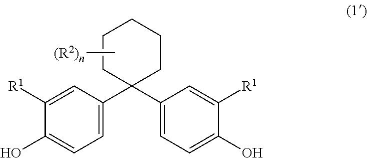

in which
R¹ is hydrogen or a C₁- to C₄-alkyl radical, preferably hydrogen,
R² is a C₁- to C₄-alkyl radical, preferably methyl radical, and
n is 0, 1, 2 or 3, preferably 3.

The diphenols of the formula (1′) and the employment thereof in homopolycarbonates are disclosed in DE 3918406 for example.

Particular preference is given to 1,1-bis-(4-hydroxyphenyl)-3,3,5-trimethylcyclohexane (bisphenol TMC) having the formula (1a):

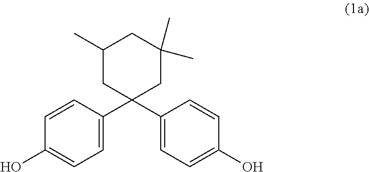 [SMILES: CC1CC(C)(C)CC(c2ccc(O)cc2)(c2ccc(O)cc2)C1]

In addition to one or more monomer units of formula (1) the copolycarbonate may contain one or more monomer unit(s) of formula (3):

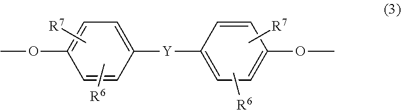

in which
R⁶ and R⁷ are independently H, C₁- to C₁₈-alkyl-, C₁- to C₁₈-alkoxy, halogen such as Cl or Br or respectively optionally substituted aryl or aralkyl, preferably H,
or C₁- to C₁₂-alkyl, more preferably H or C₁- to C₈-alkyl and most preferably H or methyl, and
Y is a single bond, —SO₂—, —CO—, —O—, —S—, C₁- to C₆-alkylene or C₂- to C₅-alkylidene, and also C₆- to C₁₂-arylene, which may optionally be fused with further heteroatom-comprising aromatic rings.

The monomer unit(s) of general formula (3) is/are introduced via one or more corresponding diphenols of general formula (3a):

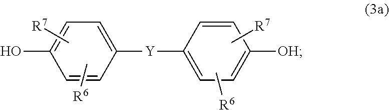

where R⁶, R⁷ and Y each have the meaning stated above in connection with formula (3).

Very particularly preferred diphenols of formula (3a) are diphenols of general formula (3b),

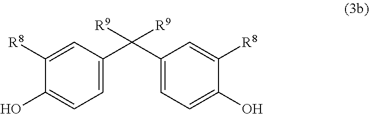

in which R⁸ is H, linear or branched C₁- to C₁₀-alkyl radicals, preferably linear or branched C₁- to C₆-alkyl radicals, more preferably linear or branched C₁- to C₄-alkyl radicals, most preferably H or a C₁-alkyl radical (methyl radical), and
in which R⁹ is linear or branched C₁- to C₁₀-alkyl radicals, preferably linear or branched C₁- to C₆-alkyl radicals, more preferably linear or branched C₁- to C₄-alkyl radicals, most preferably a C₁-alkyl radical (methyl radical).

Diphenol (3c) in particular is very particularly preferred here.

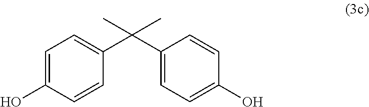 [SMILES: CC(C)(c1ccc(O)cc1)c1ccc(O)cc1]

The diphenols of the general formula (3a) may be used either alone or else in admixture with one another. The diphenols are known from the literature or producible by literature methods (see for example H. J. Buysch et al., Ullmann's Encyclopedia of Industrial Chemistry, VCH, New York 1991, 5th Ed., Vol. 19, p. 348).

The total proportion of the monomer units of formula (1) in the copolycarbonate is preferably 0.1-88 mol %, more preferably 1-86 mol %, most preferably 5-84 mol % and in particular 10-82 mol % (sum of the moles of diphenols of formula (1′) based on the sum of the moles of all diphenols employed).

Copolycarbonates may be present in the form of block or random copolycarbonates. Random copolycarbonates are particularly preferred. The ratio of the frequency of the diphenoxide monomer units in the copolycarbonate is calculated from the molar ratio of the diphenols employed.

Monomer units of general formula (2) are introduced via a diphenol of general formula (2a):

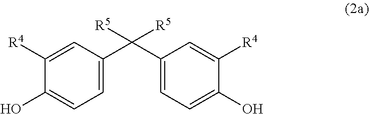

in which R⁴ is H, linear or branched C₁- to C₁₀-alkyl radicals, preferably linear or branched C₁- to C₆-alkyl radicals, more preferably linear or branched C₁- to C₄-alkyl radicals, most preferably H or a C₁-alkyl radical (methyl radical) and
in which R⁵ is linear or branched C₁- to C₁₀-alkyl radicals, preferably linear or branched C₁- to C₆-alkyl radicals, more preferably linear or branched C₁- to C₄-alkyl radicals, most preferably a C₁-alkyl radical (methyl radical).

Bisphenol A is very particularly preferred here.

In addition to one or more monomer units of general formulae (2) the homo- or copolycarbonate which is optionally additionally present may contain one or more monomer units of formula (3) as previously described for the copolycarbonate.

If the composition according to the invention comprises copolycarbonate containing monomer units of formula (1), the total amount of copolycarbonate containing monomer units of formula (1) in the composition is preferably at least 3.0 wt %, more preferably at least 5.0 wt %.

In a preferred embodiment the composition according to the invention comprises as component A a blend of the copolycarbonate comprising the monomer units of formula (I) and a bisphenol A-based homopolycarbonate.

If the composition according to the invention comprises copolycarbonate containing monomer units of formula (I), the total proportion of monomer units of formula (1) in component A is preferably 0.1-88 mol %, particularly preferably 1-86 mol %, very particularly preferably 5-84 mol % and in particular 10-82 mol %, based on the sum of the moles of all monomer units of formulae (1) and (3) in the one or more polycarbonates of component A.

Component B

The compositions according to the invention comprise as component B a mixture comprising at least one saturated or unsaturated monocarboxylic acid having a chain length of 6 to 30 carbon atoms and at least one ester of this monocarboxylic acid based on glycerol and/or diglycerol.

The esters of glycerol are based on the following base structure:

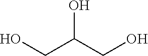

Isomers of diglycerol which form the basis of the monocarboxylic esters employed in accordance with the invention are the following:

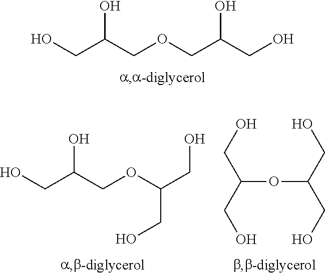

Mono- or polyesterified isomers of these formulae may be employed as the esters of diglycerol employed in accordance with the invention.

Mixtures comprising only one monocarboxylic acid and esters thereof or a mixture comprising two or more carboxylic acids and esters thereof may be employed.

Suitable monocarboxylic acids are, for example, caprylic acid (C₇H₁₅COOH, octanoic acid), capric acid (CH₉H₁₉COOH, decanoic acid), lauric acid (C₁₁H₁₃COOH, dodecanoic acid), myristic acid (C₁₃H₂₇COOH, tetradecanoic acid), palmitic acid (C₁₅H₃₁COOH, hexadecanoic acid), margaric acid (C₁₆H₃₃COOH, heptadecanoic acid), oleic acid (C₁₇H₃₃COOH, cis-9-octadecenoic acid), stearic acid (C₁₇H₃₅COOH, octadecanoic acid), arachidic acid (C₁₉H₃₉COOH, eicosanoic acid), behenic acid (C₂₁H₄₃COOH, docosanoic acid), lignoceric acid (C₂₃H₄₇COOH, tetracosanoic acid), palmitoleic acid (C₁₅H₂₉COOH, (9Z)-hexadeca-9-enoic acid), petroselic acid (C₁₇H₃₃COOH, (6Z)-octadeca-6-enoic acid, (9Z)-octadeca-9-enoic acid), elaidic acid (C₁₇H₃₃COOH, (9E)-octadeca-9-enoic acid), linoleic acid (C₁₇H₃₁COOH, (9Z,12Z)-octadeca-9,12-dienoic acid), alpha- and gamma-linolenic acid (C₁₇H₂₉COOH, (9Z,12Z,15Z)-octadeca-9,12,15-trienoic acid and (6Z,9Z,12Z)-octadeca-6,9,12-trienoic acid), arachidonic acid (C₁₉H₃₁COOH, (5Z,8Z,11Z,14Z)-eicosa-5,8,11,14-tetraenoic acid), timnodonic acid (C₁₉H₂₉COOH, (5Z,8Z,11Z,14Z,17Z)-eicosa-5,8,11,14,17-pentaenoic acid) and cervonic acid (C₂₁H₃₁COOH, (4Z,7Z,10Z,13Z,16Z,19Z)-docosa-4,7,10,13,16,19-hexaenoic acid).

Particular preference is given to saturated aliphatic monocarboxylic acids having a chain length of 8 to 30 carbon atoms, particularly preferably having 12 to 24 carbon atoms and very particularly preferably having 14 to 24 carbon atoms.

Especially suitable as component B are mixtures obtained by partial esterification of glycerol and/or diglycerol with a carboxylic acid mixture comprising two or more monocarboxylic acids having a chain length of 6 to 30 carbon atoms to afford an ester mixture. The carboxylic acid mixture preferably comprises oleic acid, and more preferably additionally stearic acid and/or palmitic acid. Component B preferably comprises, as ester mixture, monoesters and diesters of oleic acid, palmitic acid and/or stearic acid with glycerol and/or diglycerol and the carboxylic acid mixture, i.e. the corresponding carboxylic acids. Examples are glycerol monopalmitate, glycerol monooleate, diglycerol monopalmitate, diglycerol monooleate, diglycerol monostearate, diglycerol dipalmitate or diglycerol dioleate. The proportion of diesters of diglycerol is preferably smaller than the proportion of monoesters of diglycerol. Component B preferably also comprises free glycerol and/or diglycerol. However, component B may also be purified to the extent that no free glycerol and/or diglycerol remains present. Suitable mixtures are for example commercially available from Palsgaard® under the trade name Palsgaard® Polymers PGE 8100.

The OH numbers of these mixtures are preferably between 180 and 300 mg KOH/g (method 2011-0232602-92D, Currenta GmbH & Co. OHG, Leverkusen). The acid numbers of these mixtures are preferably between 1 and 6 mg KOH/g (method 2011-0527602-14D, Currenta GmbH & Co. OHG, Leverkusen). The iodine number of the mixtures according to Wijs is preferably between 40 and 80 g iodine/100 g (method 2201-0152902-95D, Currenta GmbH & Co. OHG, Leverkusen).

A preferred component B is a mixture having a content of free carboxylic acids adding up to less than 3 wt % based on the total weight of mixture B, where oleic acid makes up the largest proportion. More preferably, the content of oleic acid in the mixture is 1.5 to 2.5 wt %, especially about 2 wt %, based on the total weight of mixture B. More preferably, oleic esters of glycerol and of diglycerol form the main constituents of the ester components of component B. In total, the proportion thereof is more than 50 wt %, based on the total weight of mixture B.

The polycarbonate compositions preferably contain 0.05 to 10.0 wt %, more preferably 0.1 to 8.0 wt %, yet more preferably 0.2 to 6.0 wt %, of component B, yet more preferably 0.2 wt % to 2.0 wt %, more preferably 0.2 wt % to 1.8 wt %, most preferably 0.20 to 1.0 wt %, and most preferably to 0.8 wt %, of component B.

Component C

Preferably employed heat stabilizers are phosphorus compounds having the oxidation number+III, in particular phosphines and/or phosphites.

Preferentially suitable heat stabilizers are triphenylphosphine, tris(2,4-di-tert-butylphenyl) phosphite (Irgafos® 168), tetrakis(2,4-di-tert-butylphenyl)-[1,1-biphenyl]-4,4′-diyl bisphosphonite, octadecyl-3-(3,5-di-tert-butyl-4-hydroxyphenyl) propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36). Said heat stabilizers are employed alone or as mixtures (for example Irganox® B900 (mixture of Irgafos® 168 and Irganox® 1076 in a 1:3 ratio) or Doverphos® S-9228 with Irganox® B900/Irganox® 1076). The heat stabilizers are preferably employed in amounts of from 0.003 to 0.2 wt %.

Component D

Optionally present, in addition, are up to 6.0 wt %, preferably 0.01 to 2.0 wt %, of other conventional additives (“further additives”). The group of further additives does not include heat stabilizers since these have already been described above as component C.

Such additives as are typically added in polycarbonates are in particular antioxidants, mould release agents, flame retardants, UV absorbers, IR absorbers, antistats, optical brighteners, light-scattering agents, colourants such as organic pigments, and/or additives for laser marking as described, for example, in EP-A 0 839 623, WO-A 96/15102, EP-A 0 500 496 or “Plastics Additives Handbook”, Hans Zweifel, 5th Edition 2000, Hanser Verlag, Munich in amounts customary for polycarbonate. These additives may be added singly or else in admixture.

Preferred additives are specific UV stabilizers having as low a transmission as possible below 400 nm and as high a transmission as possible above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF, Ludwigshafen), 2-(2′-hydroxy-5′-(tert-octyl)phenyl)benzotriazole (Tinuvin® 329, BASF, Ludwigshafen), bis(3-(2H-benzotriazolyl)-2-hydroxy-5-tert-octyl)methane (Tinuvin® 360, BASF, Ludwigshafen), 2-(4,6-diphenyl-1,3,5-triazin-2-yl)-5-(hexyloxy)phenol (Tinuvin® 1577, BASF, Ludwigshafen), and also benzophenones such as 2,4-dihydroxybenzophenone (Chimassorb® 22, BASF, Ludwigshafen) and 2-hydroxy-4-(octyloxy)benzophenone (Chimassorb® 81, BASF, Ludwigshafen), 2,2-bis[[(2-cyano-1-oxo-3,3-diphenyl-2-propenyl)oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (Tinuvin® 1600, BASF, Ludwigshafen), tetraethyl-2,2′-(1,4-phenylenedimethylidene) bismalonate (Hostavin® B-Cap, Clariant AG) or N-(2-ethoxyphenyl)-N′-(2-ethylphenyl)ethanediamide (Tinuvin® 312, CAS No. 23949-66-8, BASF, Ludwigshafen).

Particularly preferred specific UV stabilizers are Tinuvin® 360, Tinuvin® 329 and/or Tinuvin® 312, very particular preference being given to Tinuvin® 329 and Tinuvin® 312.

It is also possible to employ mixtures of these ultraviolet absorbers.

It is preferable when the composition comprises ultraviolet absorbers in an amount of up to 0.8 wt %, preferably 0.05 wt %/o to 0.5 wt %, more preferably 0.1 wt % to 0.4 wt %, based on the total composition.

The compositions according to the invention may also comprise phosphates or sulphonic esters as transesterification stabilizers. Triisooctyl phosphate is preferably present as a transesterification stabilizer. Triisooctyl phosphate is preferably employed in amounts of 0.003 wt % to 0.05 wt %, more preferably 0.005 wt % to 0.04 wt % and particularly preferably 0.01 wt % to 0.03 wt %.

The composition may be free from mould release agents, for example pentaerythritol tetrastearate or glycerol monostearate.

It is particularly preferable when the compositions comprise at least one heat stabilizer (component C) and optionally, as a further additive (component D), a transesterification stabilizer, in particular triisooctyl phosphate, or a UV absorber.

Compositions according to the invention may also comprise an impact modifier as an additive (component D). Examples of impact modifiers are: acrylate core-shell systems or butadiene rubbers (Paraloid series from DOW Chemical Company); olefin-acrylate copolymers, for example Elvaloy® series from DuPont; silicone acrylate rubbers, for example Metablen® series from Mitsubishi Rayon Co., Ltd.

If the compositions according to the invention are to be transparent, they preferably do not contain any amounts of additive from the following group that have a significant effect on transparency: light-scattering agents, inorganic pigments, impact modifiers, and further preferably no additive at all from this group. A “significant effect” means an amount of these additives which leads to a reduction of more than 1% in the transmission—Ty (D65 observed at 10°), determined according to ISO 13468-2:2006 at a thickness of 4 mm—compared to a composition that does not contain these additives but is otherwise identical.

The compositions according to the invention which comprise components A to D are produced by commonplace methods of incorporation by combining, mixing and homogenizing the individual constituents, the homogenization in particular preferably being carried out in the melt by application of shear forces. Combination and mixing is optionally effected prior to melt homogenization using powder pre-mixes.

It is also possible to employ pre-mixes of pellets or pellets and powders with the components B to D.

Also usable are pre-mixes formed from solutions of the mixing components in suitable solvents, in which case homogenization is optionally effected in solution and the solvent is thereafter removed.

In particular, components B to D of the composition according to the invention are incorporable in the polycarbonate by familiar methods or as a masterbatch.

The use of masterbatches to incorporate the components B to D—singly or as mixtures—is preferable.

In this context, the composition according to the invention can be combined, mixed, homogenized and subsequently extruded in customary apparatuses such as screw extruders (TSE twin-screw extruders for example), kneaders or Brabender or Banbury mills. The extrudate can be cooled and comminuted after extrusion. It is also possible to pre-mix individual components and then to add the remaining starting materials singly and/or likewise mixed.

The combining and commixing of a pre-mix in the melt may also be effected in the plasticizing unit of an injection moulding machine. In this case, the melt is directly converted into a moulded article in the subsequent step.

The compositions according to the invention can be processed in a customary manner in standard machines, for example in extruders or injection moulding machines, to give any moulded articles, for example films, sheets or bottles.

Production of the mouldings is preferably effected by injection moulding, extrusion or from solution in a casting process.

The compositions according to the invention are suitable for producing multilayered systems. This comprises applying the polycarbonate composition in one or more layers atop a moulded article made of a plastics material. Application may be carried out at the same time as or immediately after the moulding of the moulded article, for example by foil insert moulding, coextrusion or multicomponent injection moulding. However, application may also be to the ready-moulded main body, for example by lamination with a film, by encapsulative overmoulding of an existing moulded article or by coating from a solution.

The compositions according to the invention are suitable for producing components in the automotive sector, for instance for bezels, headlight covers or frames, lenses and collimators or light guides and for producing frame components in the electricals and electronics (EE) and IT sectors, in particular for applications which impose stringent flowability requirements (thin layer applications). Such applications include, for example, screens or housings, for instance for ultrabooks or frames for LED display technologies, e.g. OLED displays or LCD displays or else for E-ink devices. Further fields of application are housing parts of mobile communication terminals, such as smartphones, tablets, ultrabooks, notebooks or laptops, but also satnavs, smartwatches or heart rate meters, and also electrical applications in thin-wall designs, for example home and industrial networking systems and smart meter housing components.

The moulded articles and extrudates made of the compositions according to the invention and also mouldings, extrudates and multilayer systems comprising the compositions according to the invention likewise form part of the subject matter of this application.

It is a particular feature of the compositions according to the invention that they exhibit exceptional rheological and optical properties on account of their content of component B. They are therefore suitable for the production of sophisticated injection-moulded parts, particularly for thin-wall applications where good flowability is required. Examples of such applications are ultrabook housing parts, laptop covers, headlight covers, LED applications or components for electricals and electronics applications. Thin-wall applications are preferably applications where there are wall thicknesses of less than about 3 mm, preferably of less than 3 mm, more preferably of less than 2.5 mm, yet more preferably of less than 2.0 mm, most preferably of less than 1.5 mm. In this context “about” is understood to mean that the actual value does not deviate substantially from the stated value, a “non-substantial” deviation being deemed to be one of not more than 25%, preferably not more than 10%.

The present invention therefore also further provides for the use of a mixture comprising at least one saturated or unsaturated monocarboxylic acid having a chain length of 6 to 30 carbon atoms and at least one ester of monocarboxylic acid based on glycerol and/or diglycerol for improving the optical properties, especially the visual transmission, of compositions comprising aromatic polycarbonate (component A), optionally thermal stabilizer (component C) and optionally further additives (component D).

The embodiments described hereinabove for the compositions according to the invention also apply—where applicable—to the use according to the invention.

The examples which follow are intended to illustrate the invention without, however, limiting said invention.

### EXAMPLES

1. Description of Raw Materials and Test Methods

The polycarbonate compositions described in the following examples were produced by compounding on a Berstorff ZE 25 extruder at a throughput of 10 kg/h. The melting temperature was 275° C.

Component A-1: Linear polycarbonate based on bisphenol A having a melt volume flow rate MVR of 12.5 cm³/(10 min) (as per ISO 1133:2012-03, at a test temperature of 300° C. and load 1.2 kg), produced by addition via a side extruder.

Component A-2: Linear polycarbonate powder based on bisphenol A having a melt volume flow rate MVR of 6 cm³/(10 min) (as per ISO 1133:2012-03, at a test temperature of 300° C. and load 1.2 kg).

Component A-3: Copolycarbonate based on bisphenol A and bisphenol TMC having a melt volume flow rate MVR of 18 cm³/(10 min) (330° C./2.16 kg) and a softening temperature (VST/B 120) of 182° C. from Covestro AG.

Component A-4: Lexan® XHT 2141 from Sabic Innovative Plastics; copolycarbonate based on bisphenol A and bisphenol of the formula (1) where R′=phenyl. The MVR is 43 cm³/10 min (330° C., 2.16 kg); the Vicat temperature (B50) is 160° C.

Component A-5: Lexan® XHT 3141 from Sabic Innovative Plastics; copolycarbonate based on bisphenol A and bisphenol of the formula (I) where R′=phenyl. The MVR is 30 cm³/10 min (330° C., 2.16 kg); the Vicat temperature (B50) is 168° C.

Component A-6: Copolycarbonate formed from bisphenol A and dihydroxydiphenyl with a melt volume flow rate MVR of 7 cm³/10 min (330° C., 2.16 kg).

Component A-7: Linear polycarbonate powder based on bisphenol A having a melt volume flow rate MVR of 9.5 cm³/(10 min) (as per ISO 1133:2012-03, at a test temperature of 300° C. and load 1.2 kg).

Component B: Mixture; Palsgaard® Polymers PGE 8100 from Palsgaard. This is a mixture comprising the esters glycerol monooleate (about 14 wt %), diglycerol monooleate (about 45 wt %), diglycerol dioleate (about 14 wt %). The amounts of free carboxylic acids in the mixture are about 2 wt % of oleic acid and less than 1 wt % of stearic acid and palmitic acid respectively.

Component C: triphenylphosphine (TPP) from BASF SE as heat stabilizer.

Component C-2: Irgafos® P-EPQ from BASF SE as thermal stabilizer.

Component D-1: triisooctyl phosphate (TOF) from Lanxess AG as transesterification stabilizer.

Component D-2: Paraloid EXL 2300; acrylate-based core-shell impact modifier from Dow Chemical Company.

Bayblend T65: PC/ABS blend from Covestro Deutschland AG.

Bayblend FR3030: Flame-retardant PC/ABS blend from Covestro Deutschland AG.

As a measure of heat resistance, the Vicat softening temperature VST/B50 or VST/B 120 was determined according to ISO 306:2014-3 on 80 mm×10 mm×4 mm test specimens with a needle load of 50 N and a heating rate of 50° C./h or 120° C./h using a Coesfeld Eco 2920 instrument from Coesfeld Materialtest.

Melt volume flow rate (MVR) was determined according to ISO 1133:2012-03 (predominantly at a test temperature of 300° C., mass 1.2 kg) using a Zwick 4106 instrument from Zwick Roell. In addition MVR was measured after a preheating time of 20 minutes. This is a measure of melt stability under elevated thermal stress.

Charpy notched impact strength was measured at room temperature according to ISO 7391-2:2006 on single-side-injected test bars measuring 80 mm×10 mm×3 mm.

Charpy impact strength was measured at room temperature according to ISO 7391-2:2006 on single-side-injected test bars measuring 80 mm×10 mm×3 mm.

Shear viscosity (melt viscosity) was determined as per ISO 11443:2005 with a Göttfert Visco-Robo 45.00 instrument.

Tensile modulus of elasticity was measured according to ISO 527-1/-2:1996-04 on single-side-injected dumbbells having a core measuring 80 mm×10 mm×4 mm.

Yellowness index (Y.I.) was determined according to ASTM E 313-10 (observer: 10°/illuminant: D65) on specimen plaques having a sheet thickness of 4 mm.

Transmission in the VIS range of the spectrum (400 nm to 800 nm) was determined to ISO 13468-2:22060 on specimen plaques having a sheet thickness of 4 mm.

Haze was determined to ASTM D1003:2013 on specimen plaques having a sheet thickness of 4 mm.

Flow path determination by means of a flow spiral: the flow spiral is a cavity arranged in spiral form and having a height of 2 mm and a width of 8 mm, into which the molten mixture is injected at a fixed pressure (here: 1130 bar). The flow paths achieved by the various samples are compared with one another; the longer the better.

The melt viscosity was measured by the cone-plate method using the MCR 301 rheometer instrument with the CP 25 measurement cone, and the measurement was made according to ISO 11443:2014-04.

Elongation at break was determined by means of a tensile test according to DIN EN ISO 527-1/-2:1996.

The specimen plaques were in each case produced by injection moulding at the melt temperatures reported in the tables which follow.

2. Compositions

TABLE 1
Inventive compositions 2 to 6 and comparative example 1

| | | 1 | | | | | |
|---|---|---|---|---|---|---|---|
| Formulation | | (comp.) | 2 | 3 | 4 | 5 | 6 |
| Component A-1¹⁾ | wt % | 93 | 93 | 93 | 93 | 93 | 93 |
| Component A-2 | wt % | 7 | 6.9 | 6.8 | 6.6 | 6.4 | 6.2 |
| Component B | wt % | — | 0.1 | 0.2 | 0.4 | 0.6 | 0.8 |
| Tests | | | | | | | |
| MVR 7′/300° C./1.2 kg | ml/(10 min) | 12.2 | 14.3 | 18.4 | 28.1 | 39.9 | 51.6 |
| MVR 20′/300° C./1.2 kg | ml/(10 min) | 12.6 | 14.3 | 18.6 | 29.8 | 39.7 | 51.4 |
| Delta MVR 20′/MVR7′ | | 0.4 | 0.0 | 0.2 | 1.7 | −0.2 | −0.2 |
| Vicat VSTB 50 | ° C. | 144.8 | 144.0 | 143.2 | 141.3 | 140.1 | 137.9 |
| Notched impact | | | | | | | |
| resistance | | | | | | | |
| at 23° C. | kJ/m² | 63z* | 63z | 65z | 64z | 61z | 62z |
| at 10° C. | kJ/m² | — | — | — | — | 59z | 8 × 61z |
| | | | | | | | 2 × 19s** |
| at 0° C. | kJ/m² | — | 59z | 59z | 60z | 5 × 57z | 2 × 58z |
| | | | | | | 5 × 19s | 8 × 17s |
| at −10° C. | kJ/m² | 58z | 8 × 57z | 3 × 59z | 2 × 56z | 2 × 57z | 15s |
| | | | 2 × 24s | 7 × 20s | 8 × 17s | 8 × 16s | |
| at −20° C. | kJ/m² | 7 × 57z | 17s | 16s | 15s | 1 × 43z | 13s |
| | | 3 × 21s | | | | 9 × 15s | |
| at −30° C. | kJ/m² | 17s | — | — | — | — | — |
| Optical properties 4 mm, | | | | | | | |
| 300° C.²⁾ | | | | | | | |
| Transmission | % | 89.06 | 89.14 | 88.92 | 89.00 | 88.87 | 88.97 |
| Haze | % | 0.53 | 0.54 | 0.77 | 0.7 | 1.05 | 0.64 |
| Y.I. | | 2.64 | 2.53 | 2.75 | 2.71 | 2.73 | 2.8 |

¹⁾contains 250 ppm of triphenylphosphine as component C;
²⁾melt temperature in the injection moulding process in the production of the test specimens;
*tough;
**brittle

It is apparent from Table I that the inventive polycarbonate compositions 2 to 6 have very good melt stabilities, as shown by the MVR values after a dwell time of 20 minutes. Comparative example 1, which does not contain any component B, by contrast, has much poorer melt volume flow rates MVR than the inventive polycarbonate compositions 2 to 6.

TABLE 2
Inventive compositions 8 to 10, additionally containing
triisooctyl phosphate (D-1), and comparative example 7

| Formulation: | | 7 (comp.) | 8 | 9 | 10 |
|---|---|---|---|---|---|
| Component A-1¹⁾ | wt % | 93 | 93 | 93 | 93 |
| Component A-2 | wt % | 6.99 | 6.59 | 6.39 | 6.19 |
| Component B | wt % | — | 0.4 | 0.6 | 0.8 |
| Component D-1 | wt % | 0.01 | 0.01 | 0.01 | 0.01 |
| Tests | | | | | |
| MVR 7′/300° C./1.2 kg | ml/(10 | 12.0 | 22.4 | 42.7 | 44.6 |
| | min) | | | | |
| MVR 20′/300° C./1.2 kg | ml/(10 | 12.3 | 24.4 | 42.3 | 43.4 |
| | min) | | | | |
| Delta MVR 20′/MVR7′ | | 0.3 | 2.0 | −0.4 | −1.2 |
| Vicat VSTB 50 | ° C. | 144.9 | 141.1 | 138.1 | 136.3 |
| Notched impact | | | | | |
| resistance | | | | | |
| at 23° C. | kJ/m² | 65z* | 66z | 66z | 55z |
| at 10° C. | kJ/m² | — | — | — | 52z |
| at 0° C. | kJ/m² | — | 59z | 59z | 14s** |
| at −10° C. | kJ/m² | 59z | 6x57z | 15s | — |
| | | | 4x18s | | |
| Impact resistance | kJ/m² | n.f. | n.f. | n.f. | n.f. |
| Optical properties 4 | | | | | |
| mm, 300° C.²⁾ | | | | | |
| Transmission | % | 89.01 | 89.35 | 89.23 | 89.34 |
| Haze | % | 0.35 | 0.31 | 0.42 | 0.25 |
| Y.I. | | 2.50 | 2.34 | 2.53 | 2.61 |

¹⁾contains 250 ppm of triphenylphosphine as component C;
²⁾melt temperature in the injection moulding process in the production of the test specimens;
n.f.: unfractured (no value, since no fracture);
*tough;
**brittle

Inventive compositions 8 to 10 comprising component B show a distinct improvement in the melt volume flow rates MVR over comparative example 7. Surprisingly, in the case of combination with triisooctyl phosphate, the optical properties were also significantly improved, which is reflected in the elevated transmission.

The inventive polycarbonate compositions 8 to 10 additionally exhibit very good melt stabilities, as shown by MVR values after a dwell time of 20 minutes.

TABLE 3
Inventive compositions 12 to 14, additionally containing
triisooctyl phosphate, and comparative example 11

| Formulation: | | 11 (comp.) | 12 | 13 | 14 |
|---|---|---|---|---|---|
| Component A-3¹⁾ | wt % | 93.00 | 93.00 | 93.00 | 93.00 |
| Component A-2 | wt % | 7.00 | 6.89 | 6.79 | 6.59 |
| Component B | wt % | — | 0.10 | 0.20 | 0.40 |
| Component D-1 | wt % | — | 0.01 | 0.01 | 0.01 |
| Tests: | | | | | |
| etaᵣₑᵢ for pellets | | 1.256 | 1.255 | 1.254 | 1.252 |
| MVR 330° C./ | ml/(10 | 17.8 | 17.2 | 21.1 | 44.4 |
| 2.16 kg | min) | | | | |
| Flow spiral (1130 | cm | 25* | 25.5 | 26.3 | 29.5 |
| bar) | | | | | |
| Melt visc. at 300° C. | | | | | |
| eta 50 | Pa · s | 1345 | 1320 | 1255 | 1128 |
| eta 100 | Pa · s | 1272 | 1252 | 1195 | 1081 |
| eta 200 | Pa · s | 1129 | 1123 | 1061 | 970 |
| eta 500 | Pa · s | 811 | 818 | 772 | 729 |
| eta 1000 | Pa · s | 566 | 571 | 538 | 516 |
| eta 1500 | Pa · s | 447 | 450 | 426 | 410 |
| eta 5000 | Pa · s | 185 | 212 | 170 | 192 |
| Melt visc. at 320° C. | | | | | |
| eta 50 | Pa · s | 756 | 698 | 676 | 513 |
| eta 100 | Pa · s | 734 | 676 | 638 | 498 |
| eta 200 | Pa · s | 690 | 632 | 596 | 469 |
| eta 500 | Pa · s | 549 | 510 | 483 | 394 |
| eta 1000 | Pa · s | 409 | 385 | 366 | 311 |
| eta 1500 | Pa · s | 326 | 311 | 299 | 259 |
| eta 5000 | Pa · s | 150 | 143 | 137 | 123 |
| Melt visc. at 330° C. | | | | | |
| eta 50 | Pa · s | 500 | 456 | 447 | 279 |
| eta 100 | Pa · s | 498 | 446 | 438 | 278 |
| eta 200 | Pa · s | 474 | 433 | 419 | 277 |
| eta 500 | Pa · s | 400 | 370 | 360 | 254 |
| eta 1000 | Pa · s | 316 | 297 | 291 | 219 |
| eta 1500 | Pa · s | 262 | 248 | 244 | 189 |
| eta 5000 | Pa · s | 127 | 121 | 120 | 102 |
| Melt visc. at 340° C. | | | | | |
| eta 50 | Pa · s | 368 | 326 | 305 | 169 |
| eta 100 | Pa · s | 365 | 322 | 300 | 168 |
| eta 200 | Pa · s | 355 | 313 | 295 | 167 |
| eta 500 | Pa · s | 310 | 279 | 263 | 158 |
| eta 1000 | Pa · s | 257 | 232 | 221 | 141 |
| eta 1500 | Pa · s | 219 | 201 | 192 | 131 |
| eta 5000 | Pa · s | 111 | 105 | 101 | 79 |
| Melt visc. at 360° C. | | | | | |
| eta 50 | Pa · s | 199 | 162 | 146 | 66 |
| eta 100 | Pa · s | 196 | 159 | 144 | 65 |
| eta 200 | Pa · s | 190 | 154 | 140 | 64 |
| eta 500 | Pa · s | 178 | 149 | 132 | 62 |
| eta 1000 | Pa · s | 158 | 135 | 121 | 60 |
| eta 1500 | Pa · s | 141 | 122 | 111 | 58 |
| eta 5000 | Pa · s | 84 | 74 | 70 | 45 |
| Vicat VSTB 120 | ° C. | 180.9 | 180.3 | 178.7 | 176.6 |
| Tensile properties | | | | | |
| Yield stress | N/mm² | 72 | 73 | 74 | 75 |
| Elongation at yield | % | 6.8 | 6.7 | 6.6 | 6.5 |
| Ultimate tensile | N/mm² | 64 | 72 | 70 | 73 |
| strength | | | | | |
| Elongation at break | % | 84 | 126 | 118 | 129 |
| Modulus of | N/mm² | 2357 | 2381 | 2438 | 2457 |
| elasticity | | | | | |
| Optical data | | | | | |
| 4 mm, 330° C.²⁾ | | | | | |
| Transmission | % | 88.94 | 89.35 | 89.62 | 89.64 |
| Haze | % | 0.44 | 0.3 | 0.3 | 0.28 |
| Y.I. | | 3.39 | 2.95 | 2.63 | 2.46 |

¹⁾contains 250 ppm of triphenylphosphine as component C;
²⁾melt temperature in the injection moulding process in the production of the test specimens

Inventive examples 12 to 14 comprising component B and component D, i.e. triisooctyl phosphate, exhibit distinctly reduced melt viscosities compared to comparative example II at all shear rates and temperatures measured. The optical properties of transmission, haze and yellowness index are significantly improved. At the same time, an increase in the modulus of elasticity is found.

TABLE 4
Inventive examples 16, 17, 19 and 20 and comparative examples 15 and 18

| | | 15 | | | 18 | | |
|---|---|---|---|---|---|---|---|
| Formulation: | | (comp.) | 16 | 17 | (comp.) | 19 | 20 |
| Component A-4 | wt % | 100 | 99.8 | 99.6 | | | |
| Component A-5 | wt % | | | | 100 | 99.8 | 99.6 |
| Component B | wt % | | 0.2 | 0.4 | | 0.2 | 0.4 |
| Tests | | | | | | | |
| Cone/plate | | | | | | | |
| rheology | | | | | | | |
| Melt visc. at 260° C. | | | | | | | |
| eta 471 | Pa · s | 1020 | 601 | 681 | 856 | 557 | 559 |
| eta 329 | Pa · s | 1220 | 775 | 842 | 1020 | 697 | 640 |
| eta 229 | Pa · s | 1450 | 976 | 996 | 1190 | 838 | 719 |
| eta 160 | Pa · s | 1690 | 1200 | 1140 | 1370 | 962 | 791 |
| eta 112 | Pa · s | 1950 | 1420 | 1280 | 1540 | 1080 | 856 |
| eta 77.8 | Pa · s | 2210 | 1620 | 1400 | 1710 | 1170 | 913 |
| eta 54.3 | Pa · s | 2470 | 1770 | 1500 | 1880 | 1240 | 960 |
| eta 37.9 | Pa · s | 2720 | 1890 | 1590 | 2020 | 1300 | 997 |
| eta 26.4 | Pa · s | 2940 | 2000 | 1670 | 2150 | 1350 | 1030 |
| eta 18.4 | Pa · s | 3140 | 2080 | 1720 | 2250 | 1390 | 1050 |
| eta 12.9 | Pa · s | 3310 | 2150 | 1770 | 2340 | 1410 | 1060 |
| eta 8.97 | Pa · s | 3450 | 2200 | 1800 | 2400 | 1430 | 1070 |
| eta 6.25 | Pa · s | 3550 | 2230 | 1820 | 2450 | 1440 | 1080 |
| eta 4.36 | Pa · s | 3630 | 2250 | 1830 | 2480 | 1450 | 1080 |
| eta 3.04 | Pa · s | 3690 | 2270 | 1840 | 2500 | 1450 | 1080 |
| eta 2.12 | Pa · s | 3720 | 2280 | 1840 | 2520 | 1450 | 1080 |
| eta 1.48 | Pa · s | 3750 | 2280 | 1840 | 2530 | 1450 | 1080 |
| eta 1.03 | Pa · s | 3770 | 2280 | 1830 | 2540 | 1450 | 1080 |
| eta 0.721 | Pa · s | 3780 | 2280 | 1830 | 2550 | 1450 | 1070 |
| eta 0.503 | Pa · s | 3780 | 2260 | 1810 | 2550 | 1440 | 1070 |
| Melt visc. at 280° C. | | | | | | | |
| eta 471 | Pa · s | 466 | 435 | 343 | 568 | 362 | 326 |
| eta 329 | Pa · s | 581 | 484 | 381 | 651 | 409 | 356 |
| eta 229 | Pa · s | 704 | 531 | 419 | 729 | 476 | 382 |
| eta 160 | Pa · s | 808 | 574 | 453 | 799 | 529 | 404 |
| eta 112 | Pa · s | 896 | 610 | 482 | 860 | 560 | 422 |
| eta 77.8 | Pa · s | 966 | 640 | 506 | 912 | 583 | 436 |
| eta 54.3 | Pa · s | 1030 | 663 | 525 | 955 | 601 | 446 |
| eta 37.9 | Pa · s | 1080 | 680 | 539 | 989 | 614 | 454 |
| eta 26.4 | Pa · s | 1120 | 693 | 550 | 1020 | 623 | 459 |
| eta 18.4 | Pa · s | 1150 | 700 | 556 | 1030 | 629 | 462 |
| eta 12.9 | Pa · s | 1170 | 703 | 560 | 1050 | 632 | 463 |
| eta 8.97 | Pa · s | 1180 | 704 | 562 | 1060 | 634 | 464 |
| eta 6.25 | Pa · s | 1190 | 703 | 563 | 1060 | 636 | 465 |
| eta 4.36 | Pa · s | 1200 | 701 | 563 | 1060 | 636 | 465 |
| eta 3.04 | Pa · s | 1200 | 699 | 564 | 1070 | 636 | 465 |
| eta 2.12 | Pa · s | 1200 | 694 | 563 | 1070 | 635 | 465 |
| eta 1.48 | Pa · s | 1200 | 689 | 564 | 1070 | 635 | 465 |
| eta 1.03 | Pa · s | 1210 | 683 | 565 | 1070 | 635 | 465 |
| eta 0.721 | Pa · s | 1210 | 676 | 568 | 1070 | 634 | 466 |
| eta 0.503 | Pa · s | 1200 | 665 | 572 | 1070 | 631 | 467 |
| Melt visc. at 300° C. | | | | | | | |
| eta 471 | Pa · s | 397 | 266 | 232 | 329 | 197 | 148 |
| eta 329 | Pa · s | 434 | 28 | 248 | 357 | 208 | 156 |
| eta 229 | Pa · s | 469 | 303 | 262 | 383 | 217 | 162 |
| eta 160 | Pa · s | 498 | 318 | 273 | 405 | 225 | 167 |
| eta 112 | Pa · s | 523 | 330 | 282 | 422 | 230 | 171 |
| eta 77.8 | Pa · s | 543 | 339 | 288 | 436 | 234 | 174 |
| eta 54.3 | Pa · s | 557 | 345 | 292 | 446 | 236 | 176 |
| eta 37.9 | Pa · s | 567 | 349 | 295 | 453 | 238 | 177 |
| eta 26.4 | Pa · s | 575 | 352 | 297 | 458 | 238 | 177 |
| eta 18.4 | Pa · s | 579 | 353 | 298 | 461 | 238 | 177 |
| eta 12.9 | Pa · s | 582 | 354 | 298 | 463 | 238 | 178 |
| eta 8.97 | Pa · s | 583 | 354 | 298 | 464 | 238 | 178 |
| eta 6.25 | Pa · s | 584 | 354 | 298 | 464 | 238 | 178 |
| eta 4.36 | Pa · s | 585 | 353 | 299 | 465 | 237 | 178 |
| eta 3.04 | Pa · s | 585 | 353 | 299 | 465 | 237 | 179 |
| eta 2.12 | Pa · s | 585 | 353 | 300 | 465 | 236 | 179 |
| eta 1.48 | Pa · s | 586 | 353 | 302 | 466 | 236 | 181 |
| eta 1.03 | Pa · s | 586 | 353 | 304 | 466 | 235 | 183 |
| eta 0.721 | Pa · s | 588 | 353 | 308 | 466 | 235 | 187 |
| eta 0.503 | Pa · s | 589 | 353 | 313 | 465 | 234 | 193 |
| Mₙ | g/mol | 8960 | 8487 | 8498 | 9085 | 8882 | 9017 |
| M_{w} | g/mol | 21042 | 20665 | 20437 | 22490 | 22136 | 22053 |
| T_{G} | ° C. | 172.5 | 169.2 | 167.8 | 163.0 | 160.6 | 160.0 |

Inventive examples 16 and 17 and 19 and 20 show distinctly reduced melt viscosities at all measured shear rates and temperatures compared to comparative examples 15 and 18 respectively.

TABLE 5
Inventive examples 22 to 26 and comparative example 21

| | | 21 | | | | | |
|---|---|---|---|---|---|---|---|
| Formulation: | | (comp.) | 22 | 23 | 24 | 25 | 26 |
| Component A-6 | wt % | 93 | 93 | 93 | 93 | 93 | 93 |
| Component A-2 | wt % | 7 | 6.9 | 6.8 | 6.6 | 6.4 | 6.2 |
| Component B | wt % | — | 0.1 | 0.2 | 0.4 | 0.6 | 0.8 |
| Tests | | | | | | | |
| MVR 7′ kg | ml/(10 min) | 7.6 | 7.9 | 8.1 | 8.5 | 9.1 | 10.2 |
| MVR 20′ kg | ml/(10 min) | 7.9 | 7.9 | 8.5 | 9.5 | 10.8 | 12.6 |
| Delta MVR 20′/MVR 7′ | | 0.3 | 0.0 | 0.4 | 1.0 | 1.7 | 2.4 |
| Vicat | ° C. | 153.3 | 152.3 | 151 | 149.6 | 147.8 | 146.2 |
| Melt viscosity at 280° C. | | | | | | | |
| eta 50 | Pa · s | 1150 | 1063 | 1053 | 1069 | 995 | 933 |
| eta 100 | Pa · s | 1114 | 1035 | 1030 | 1039 | 970 | 907 |
| eta 200 | Pa · s | 1033 | 960 | 949 | 963 | 908 | 847 |
| eta 500 | Pa · s | 785 | 753 | 739 | 756 | 718 | 674 |
| eta 1000 | Pa · s | 549 | 534 | 524 | 534 | 513 | 488 |
| eta 1500 | Pa · s | 423 | 413 | 406 | 413 | 398 | 384 |
| eta 5000 | Pa · s | 180 | 177 | 175 | 176 | 172 | 166 |
| Melt viscosity at 300° C. | | | | | | | |
| eta 50 | Pa · s | | | | 530 | 422 | 423 |
| eta 100 | Pa · s | | | | 513 | 420 | 419 |
| eta 200 | Pa · s | | | | 484 | 416 | 417 |
| eta 500 | Pa · s | | | | 430 | 377 | 377 |
| eta 1000 | Pa · s | | | | 350 | 315 | 313 |
| eta 1500 | Pa · s | | | | 290 | 269 | 265 |
| eta 5000 | Pa · s | | | | 138 | 130 | 129 |
| Melt viscosity at 320° C. | | | | | | | |
| eta 50 | Pa · s | | | | 312 | 292 | 231 |
| eta 100 | Pa · s | | | | 300 | 282 | 230 |
| eta 200 | Pa · s | | | | 291 | 271 | 229 |
| eta 500 | Pa · s | | | | 273 | 253 | 219 |
| eta 1000 | Pa · s | | | | 239 | 222 | 197 |
| eta 1500 | Pa · s | | | | 211 | 197 | 173 |
| eta 5000 | Pa · s | | | | 115 | 109 | 102 |
| Notched impact resistance | | | | | | | |
| RT | kJ/m² | 50z | 50z | 53z | 51z | 68z | 51z |
| −20° C. | kJ/m² | 45z | 45z | 45z | 45z | 46z | 45z |
| −40° C. | kJ/m² | 44z | 38z | 40z | 40z | 44z | 40z |
| −50° C. | kJ/m² | 8 × 34z* | 8 × 34z | 9 × 33z | 8 × 34z | 9 × 35z | 5 × 33z |
| | | 2 × 29s** | 2 × 29s | 1 × 30s | 2 × 29s | 1 × 29s | 5 × 28s |
| Optical properties 4 mm, | | | | | | | |
| 300° C.¹⁾ | | | | | | | |
| Transmission | % | 87.43 | 87.35 | 87.60 | 87.41 | 87.41 | 87.39 |
| Y.I. | | 5.32 | 5.56 | 4.81 | 4.98 | 4.96 | 4.79 |
| Optical properties 4 mm, | | | | | | | |
| 320° C. | | | | | | | |
| Transmission | % | 87.57 | 87.51 | 87.70 | 87.58 | 87.51 | 87.47 |
| Y.I. | | 5.22 | 5.20 | 4.59 | 4.71 | 4.74 | 4.75 |

¹⁾melt temperature in the injection moulding process in the production of the test specimens;
*tough;
**brittle

Inventive examples 22 to 26 exhibit distinctly reduced melt viscosities compared to comparative example 21 at all shear rates and temperatures measured. The good low-temperature toughness is maintained; the yellowness index is reduced.

TABLE 6
Inventive examples 28 to 30 and comparative example 27

| | | 27 | | | |
|---|---|---|---|---|---|
| Formulation | | (comp.) | 28 | 29 | 30 |
| Component A-7 | wt % | 93.00 | 93.00 | 93.00 | 93.00 |
| Component A-2 | wt % | 2.89 | 2.79 | 2.69 | 2.59 |
| Component C-2 | wt % | 0.10 | 0.10 | 0.10 | 0.10 |
| Component D-2 | wt % | 4.00 | 4.00 | 4.00 | 4.00 |
| Component B | wt % | | 0.1 | 0.2 | 0.3 |
| Component D-1 | wt % | 0.01 | 0.01 | 0.01 | 0.01 |
| MVR | ml/(10 min) | 8.3 | 9.2 | 14.4 | 20.2 |
| IMVR20′ | ml/(10 min) | 9.2 | 10 | 16.5 | 22.6 |
| Delta MVR/IMVR20′ | | 0.9 | 0.8 | 2.1 | 2.4 |
| Vicat | ° C. | 144.5 | 144.5 | 143.1 | 142.0 |
| Melt visc. at 280° C. | | | | | |
| eta 50 | Pa · s | 1015 | 976 | 871 | 788 |
| eta 100 | Pa · s | 964 | 929 | 845 | 748 |
| eta 200 | Pa · s | 873 | 842 | 765 | 685 |
| eta 500 | Pa · s | 673 | 651 | 609 | 544 |
| eta 1000 | Pa · s | 487 | 473 | 449 | 408 |
| eta 1500 | Pa · s | 383 | 372 | 357 | 327 |
| eta 5000 | Pa · s | 168 | 165 | 159 | 151 |
| Melt visc. at 300° C. | | | | | |
| eta 50 | Pa · s | 502 | 486 | 439 | 386 |
| eta 100 | Pa · s | 491 | 476 | 430 | 377 |
| eta 200 | Pa · s | 469 | 455 | 408 | 367 |
| eta 500 | Pa · s | 400 | 390 | 351 | 317 |
| eta 1000 | Pa · s | 321 | 316 | 287 | 264 |
| eta 1500 | Pa · s | 268 | 266 | 250 | 227 |
| eta 5000 | Pa · s | 129 | 129 | 125 | 117 |
| Melt visc. at 320° C. | | | | | |
| eta 50 | Pa · s | 293 | 291 | 268 | 224 |
| eta 100 | Pa · s | 289 | 289 | 264 | 219 |
| eta 200 | Pa · s | 284 | 286 | 260 | 210 |
| eta 500 | Pa · s | 252 | 256 | 235 | 192 |
| eta 1000 | Pa · s | 215 | 218 | 202 | 169 |
| eta 1500 | Pa · s | 189 | 191 | 178 | 154 |
| eta 5000 | Pa · s | 103 | 105 | 101 | 90 |
| Notched impact | | | | | |
| resistance | | | | | |
| 23° C. | kJ/m² | 63z | 64z | 63z | 64z |
| −20° C. | kJ/m² | 58z | 58z | 57z | 57z |
| −30° C. | kJ/m² | 56z | 56z | 56z | 54z |
| −40° C. | kJ/m² | 20s | 20s | 20s | 19s |

Inventive examples 28 to 30 exhibit distinctly reduced melt viscosities compared to comparative example 27 at all shear rates and temperatures measured. The good low-temperature toughness is maintained.

TABLE 7
Inventive examples 32 to 34 and 36 to 38 and comparative examples 31 and 35

| | | 31 | | | | 35 | | | |
|---|---|---|---|---|---|---|---|---|---|
| Formulation | | (comp.) | 32 | 33 | 34 | (comp.) | 36 | 37 | 38 |
| Bayblend T65 | wt % | 100.00 | 99.80 | 99.60 | 99.40 | | | | |
| Bayblend FR3030 | wt % | | | | | 100.00 | 99.80 | 99.60 | 99.40 |
| Component B | wt % | | 0.20 | 0.40 | 0.60 | | 0.20 | 0.40 | 0.60 |
| Tests | | | | | | | | | |
| MVR 260° C./5 kg | ml/(10 min) | 14.5 | 14.8 | 16.9 | 18.4 | 4.2 | 4.5 | 4.8 | 5.3 |
| IMVR20′260° C./5 kg | ml(10 min) | 12.5 | 14.0 | 17.8 | 21.1 | 4.1 | 4.5 | 4.9 | 5.1 |
| Delta MVR/MVR20′ 260° C./5 kg | | −2.0 | −0.8 | 0.9 | 2.7 | −0.1 | 0.0 | 0.1 | −0.2 |
| Vicat VSTB 120 | ° C. | 115.7 | 115.2 | 113.7 | 113.3 | 113.5 | 112.4 | 111 | 110.6 |
| Melt visc. at 260° C. | | | | | | | | | |
| eta 50 | Pa · s | 923 | 914 | 844 | 804 | 1545 | 1483 | 1419 | 1406 |
| eta 100 | Pa · s | 724 | 717 | 667 | 639 | 1232 | 1182 | 1145 | 1129 |
| eta 200 | Pa · s | 542 | 541 | 506 | 485 | 967 | 927 | 892 | 886 |
| eta 500 | Pa · s | 336 | 333 | 313 | 308 | 641 | 625 | 597 | 601 |
| eta 1000 | Pa · s | 219 | 210 | 206 | 205 | 438 | 424 | 407 | 411 |
| eta 1500 | Pa · s | 167 | 168 | 158 | 158 | 338 | 328 | 313 | 318 |
| eta 5000 | Pa · s | 74 | 75 | 71 | 71 | 143 | 140 | 135 | 137 |
| Melt visc. at 280° C. | | | | | | | | | |
| eta 50 | Pa · s | 550 | 501 | 437 | 379 | — | — | — | — |
| eta 100 | Pa · s | 437 | 410 | 371 | 355 | — | — | — | — |
| eta 200 | Pa · s | 341 | 328 | 296 | 285 | — | — | — | — |
| eta 500 | Pa · s | 230 | 224 | 206 | 200 | — | — | — | — |
| eta 1000 | Pa · s | 158 | 157 | 146 | 140 | — | — | — | — |
| eta 1500 | Pa · s | 124 | 123 | 115 | 112 | — | — | — | — |
| eta 5000 | Pa · s | 56 | 56 | 53 | 51 | — | — | — | — |
| Melt visc. at 300° C. | | | | | | | | | |
| eta 50 | Pa · s | 302 | 278 | 236 | 229 | — | — | — | — |
| eta 100 | Pa · s | 234 | 229 | 192 | 184 | — | — | — | — |
| eta 200 | Pa · s | 200 | 184 | 158 | 148 | — | — | — | — |
| eta 500 | Pa · s | 146 | 136 | 118 | 112 | — | — | — | — |
| eta 1000 | Pa · s | 107 | 102 | 93 | 88 | — | — | — | — |
| eta 1500 | Pa · s | 88 | 85 | 77 | 75 | — | — | — | — |
| eta 5000 | Pa · s | 44 | 43 | 40 | 39 | — | — | — | — |
| Notched impact resistance | | | | | | | | | |
| 25° C. | kJ/m² | 82z | 61z | 61z | 66z | 49z | 49z | 46z | 43z |
| 10° C. | kJ/m² | | | | | 35z | 34z | 23s | 18s |
| 0° C. | kJ/m² | | | | | 17s | 17s | 16s | 15s |
| −10° C. | kJ/m² | | | | | | | | |
| −20° C. | kJ/m² | 100z | 81z | 63z | 80z | 13s | 13s | | |
| −30° C. | kJ/m² | | | | | | | | |
| −40° C. | kJ/m² | 92z | 99z | 107z | 87z | | | | |
| −50° C. | kJ/m² | 3 × 36z | 3 × 34z | 2 × 37z | 4 × 37z | | | | |
| | | 7 × 23s | 7 × 24s | 8 × 23s | 6 × 23s | | | | |
| −60° C. | kJ/m² | 20s | 21s | 20s | 19s | | | | |

Inventive examples 32 to 34 and 36 to 38 show reduced melt viscosities at all measured shear rates and temperatures compared to comparative examples 31 and 35 respectively. The good low-temperature toughness is maintained.

1.-15. (canceled)

16. A composition comprising
A) 20.0 wt % to 99.95 wt % of aromatic polycarbonate and
B) 0.05 wt % to 10.0 wt % of a mixture comprising at least one saturated or unsaturated monocarboxylic acid having a chain length of 6 to 30 carbon atoms and at least one ester of this monocarboxylic acid based on glycerol and/or diglycerol.

17. The composition according to claim 16, comprising at least one monocarboxylic acid selected from the group consisting of caprylic acid, capric acid, lauric acid, myristic acid, palmitic acid, margaric acid, stearic acid, arachidic acid, behenic acid, lignoceric acid, palmitoleic acid, petroselic acid, oleic acid, elaidic acid, linoleic acid, linolenic acid, arachidonic acid, timnodonic acid and cervonic acid.

18. The composition according to claim 16, wherein component B is a mixture obtainable by partial esterification of glycerol and/or diglycerol with a monocarboxylic acid mixture comprising two or more monocarboxylic acids having a chain length of 6 to 30 carbon atoms.

19. The composition according to claim 18, wherein the monocarboxylic acid mixture comprises oleic acid.

20. The composition according to claim 16, wherein the amount of component B is 0.05 to 1.0 wt %.

21. The composition according to claim 16, wherein the amount of aromatic polycarbonate is at least 75 wt %.

22. The composition according to claim 16, consisting of the following components:
A) 87.0 wt % to 99.95 wt % of aromatic polycarbonate,
B) 0.05 wt % to 6.0 wt % of the mixture comprising at least one saturated or unsaturated monocarboxylic acid having a chain length of 6 to 30 carbon atoms and at least one ester of this monocarboxylic acid based on glycerol or diglycerol,
C) 0.0 wt % to 1.0 wt % of thermal stabilizer and
D) 0.0 wt % to 6.0 wt % of one or more further additives from the group of the antioxidants, demoulding agents, flame retardants, UV absorbers, IR absorbers, antistats, optical brighteners, colourants from the group of the organic or inorganic pigments, additives for laser marking and/or impact modifiers.

23. The composition according to claim 16, wherein the composition comprises a thermal stabilizer.

24. The composition according to claim 16, wherein the composition comprises, as component A, one or more copolycarbonates containing the monomer units of the formula (1) 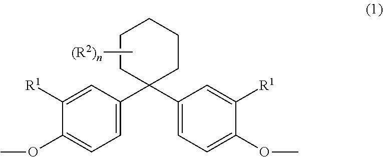
in which
R1 is hydrogen or a C1- to C4-alkyl radical,
R2 is a C1- to C4-alkyl radical and
n is 0, 1, 2 or 3,
optionally in combination with a further aromatic homo- or copolycarbonate containing one or more monomer units of the general formula (2) 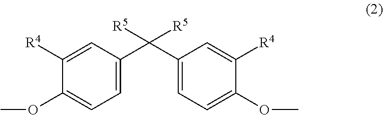
in which
R4 is H or a linear or branched C1- to C10-alkyl radical and
R⁵ is a linear or branched C₁- to C₁₀-alkyl radical;
where the further homo- or copolycarbonate which is optionally additionally present does not have any monomer units of the formula (1).

25. The composition according to claim 24, wherein the proportion of the monomer units of the formula (1a) in the copolycarbonate is 0.1-88 mol %, based on the sum total of the diphenol monomer units present in the copolycarbonate.

26. The composition according to claim 24, wherein the copolycarbonate containing the monomer units of the formula (1) additionally contains monomer units of the formula (3) 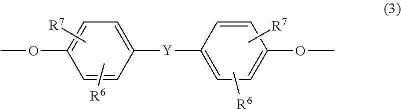
in which
R⁶ and R⁷ are independently H, a C₁- to C₁₈-alkyl radical, a C₁- to C₁₈-alkoxy radical, halogen or an in each case optionally substituted aryl or aralkyl radical and
Y is a single bond, —SO₂-, —CO—, —O—, —S—, a C₁- to C₆-alkylene radical or C₂- to C₅-alkylidene radical, a C₆- to C₁₂-arylene radical which may optionally be fused to further aromatic rings containing heteroatoms.

27. The composition according to claim 24, wherein the composition comprises, as component A, a blend of the copolycarbonate containing the monomer units of the formula (1) and bisphenol A homopolycarbonate.

28. The composition according to claim 24, wherein the amount of copolycarbonate containing the monomer units of the formula (1) in the composition is at least 3 wt %.

29. A Moulding, extrudate or multilayer system comprising the composition according to claim 16.

30. The moulding according to claim 29, having a wall thickness of less than 3 mm.
